(19) United States
(12) Patent Application Publication
(10) Pub. No.: US 2024/0401816 A1
(43) Pub. Date: Dec. 5, 2024

(54) TREATING A COOKING PRODUCT USING STEAM

(71) Applicant: BSH Hausgeräte GmbH, Munich (DE)

(72) Inventors: Kerstin Feldmann, Bretten (DE); Dieter Lego, Karlsruhe (DE)

(21) Appl. No.: 18/291,596

(22) PCT Filed: Jul. 7, 2022
(86) PCT No.: PCT/EP2022/068894

§ 371 Date: Jan. 24, 2024

(30) Foreign Application Priority Data
Aug. 4, 2021 (DE) 102021208449.4

(51) Int. Cl. F24C 7/08; A23L 5/10; A47J 27/04; A47J 36/32; F24C 15/32

(52) U.S. Cl. CPC F24C 7/08; A23L 5/13; A47J 27/04; A47J 36/32; F24C 15/325; F24C 15/327; A47J 2027/043

(57) ABSTRACT

A steam cooking appliance includes a pressureless cooking chamber, a cooking chamber heat radiator designed to heat the cooking chamber, a cooking chamber temperature sensor designed to detect a cooking chamber temperature, a steam generator including a heating element designed to heat water to produce steam for supply to the cooking chamber, a first regulator operably connected to the cooking chamber heat radiator and designed to use during a regulating phase the cooking chamber temperature as a control variable and to use a first regulator target value as a reference variable, and a second regulator operably connected to the heating element of the steam generator and designed to adopt during the regulating phase the cooking chamber temperature as a control variable and to adopt a second regulator target value as a reference variable. The first regulator target value is hereby greater than or equal to the second regulator target value.

The invention relates to a steam cooking appliance having a pressureless cooking chamber, at least one cooking chamber heat radiator for heating the cooking chamber, a cooking chamber temperature sensor for detecting a cooking chamber temperature, a steam generator with at least one heating element for heating water to produce steam, which can be supplied to the cooking chamber, at least one first regulator for actuating the at least one cooking chamber heat radiator, and at least one second regulator for actuating the at least one heating element of the steam generator. The invention also relates to a method for operating such a steam cooking appliance. The invention can be applied particularly advantageously to the treatment of food with superheated steam.

EP 1 855 058 A1 discloses a method for cooking food in a cooking chamber with steam, steam being supplied to the cooking chamber from a steam generator, a measuring opening being located on the cooking chamber, at the outer mouth of which a temperature Ts is measured, and a closable opening also being arranged on the cooking chamber, the closable opening being at least partially opened when a rise in the temperature Ts above a threshold To is detecting during cooking with steam. This allows an essentially pure steam atmosphere to be generated in the cooking chamber, in particular with a concentration of pure oxygen below 2 percent by volume.

EP 2 789 918 A1 discloses a method for cooking a food in a cooking appliance with a cooking chamber for a cooking period during which a temperature of the food to be cooked is measured and wherein at least during a regulating phase of the food temperature for the cooking period a cooking chamber temperature in the cooking chamber away from the food is controlled so that the food temperature follows a time-dependent food temperature setpoint pattern, the food to be cooked being introduced into the cooking chamber and the food temperature setpoint pattern having at least two regions with different gradients, the second region, which follows the first, having a shallower gradient than the first region.

EP2993416-B1 discloses a cooking appliance, which is arranged to supply superheated steam while food is being cooked, the cooking appliance comprising the following: a main body, which has an openable front and in which a cooking chamber is arranged; a heating chamber, which is set up in the main body, to connect to the cooking chamber; a steam generator, which is arranged to generate steam injected into the heating chamber; a convection heating device, which is arranged in the heating chamber, the convection heating device being designed to heat the heating chamber and the cooking chamber, and a steam supply tube connecting the steam generator and the heating chamber, so that the steam released from the steam generator is fed to the heating chamber, characterized in that the steam supply tube has a steam outlet opening, through which superheated steam is released, the convection heating device being designed to heat steam released from the steam generator and convert it to superheated steam, while the steam moves along the steam supply tube, the steam being injected into the heating chamber and being fed into the cooking chamber in a superheated steam state; and the steam outlet opening opening out in the direction of an upper section of the heating chamber so that superheated steam is released in the direction of the upper section of the heating chamber.

It is the object of the present invention to at least partially eliminate the disadvantages of the prior art and in particular to allow a steam cooking operation to be performed faster and less aggressively without adversely affecting the quality of a cooking result.

Said object is achieved according to the features of the independent claims. Preferred embodiments will emerge in particular from the dependent claims.

The object is achieved by a steam cooking appliance comprising:
an in particular pressureless cooking chamber,
at least one cooking chamber heat radiator for heating the cooking chamber,
a cooking chamber temperature sensor for detecting a cooking chamber temperature,
a steam generator with at least one heating element for heating water to produce steam, which can be supplied to the cooking chamber,
at least one first regulator for actuating the at least one cooking chamber heat radiator, and
at least one second regulator for actuating the at least one heating element of the steam generator, the steam cooking appliance being designed, at least during a regulating phase
to use the cooking chamber temperature as a control variable of the at least one first regulator and a first regulator target value as its reference variable,
to use the cooking chamber temperature as a control variable of the at least one second regulator and a second regulator target value as its reference variable, wherein
the first regulator target value is greater than or equal to the second regulator target value.

This steam cooking appliance has the advantage that, above all for long steam applications, the cooking period required to achieve a specific cooking result can be significantly reduced. For steam-cooking potatoes for example the time saving is 30%. The time saving in turn advantageously means that fewer nutrients and water-soluble vitamins are washed out of the food and secondary phytonutrients are better conserved. The shorter cooking period can also improve the cooking result, for example green beans have a better color/reduced chlorophyll degradation. A better cooking result can be achieved in particular with foods containing fats.

A combination of steam and conventional cooking modes (e.g. top heat, bottom heat, hot air, etc.) is advantageously selected so that very high humidity or moisture content is maintained continuously in the cooking chamber. The atmospheric air is displaced by the water vapor, it being possible to keep a residual oxygen content (which can serve as an indicator of humidity in the cooking chamber) in particular at least as low as for full steam operation without providing conventional heating modes. This recognizes that at cooking chamber temperatures above the boiling point of water the steam supplied to the cooking chamber has a cooling effect while at cooking chamber temperatures below the boiling point it has a heating effect. Therefore in particular at cooking chamber temperatures above the boiling point of water (approx. 100° C.) equilibrium should advantageously be achieved between the energy input of the steam and the energy input by way of the conventional heating units. This is achieved by an appropriate ratio of the reference variable or target value of the second regulator of the steam generator and the reference variable or target value of the first regulator of the conventional operating mode. This can advantageously be implemented easily without or with only slight structural changes, in particular without providing or actuating opening valves, such as flaps, etc.

In one development the steam cooking appliance is a household steam cooking appliance.

In one development the steam cooking appliance is an oven with an additional steam generation function. The steam cooking appliance can therefore be used as a conventional oven in operating modes other than a steam cooking operation or sequence. It is also possible to use the steam cooking appliance for a simple steam cooking operation without using conventional heating modes.

A pressureless cooking chamber refers in particular to a cooking chamber in which no or no significant overpressure builds up or can build up.

In one development the at least one cooking chamber heat radiator comprises an electric resistance heating unit, in particular a tubular heating unit, for example a top heat heating unit, grill heating unit, bottom heat heating unit, ring heating unit, etc. In one development the at least one cooking chamber heat radiator comprises a, for example flat, IR radiator. The at least one cooking chamber heat radiator emits heat radiation into the cooking chamber.

Respective first regulators can be assigned to multiple cooking chamber heat radiators to actuate or energize them. Alternatively or additionally it can be possible to actuate at least two cooking chamber heat radiators, in particular all the cooking chamber heat radiators, by way of the same first regulator. The cooking chamber heat radiators can in particular be activated and deactivated individually.

The cooking chamber temperature sensor can be for example a Ptxxxx (e.g. Pt500 or Pt1000) thermosensor.

That the steam can be supplied to the cooking chamber means that the steam generator generates steam that fills the cooking chamber.

In one development the steam generator is a steam generator arranged outside the cooking chamber. It has at least one heating element for heating water supplied to the steam generator to produce steam. The steam is fed to the cooking chamber. The steam generator can in particular comprise multiple heating circuits each with at least one heating element, which can be actuated or energized individually by way of the second regulator.

In one development the steam generator is a steam generator arranged within the cooking chamber, for example a steam generator arranged on an inner wall of the cooking chamber. The steam generator can also be present in the form of a bottom shell that can be filled and in particular also be automatically refilled with water and can be heated by means of at least one heating element arranged outside the wall of the cooking chamber.

The first regulator and/or the second regulator can be a PID controller. To actuate the associated component(s), the first regulator and/or the second regulator can output a regulator signal in the form of a PWM signal, which activates a corresponding power relay (PWM controller) for example. The duty cycle or heating power induced thereby into the at least one cooking chamber heat radiator or the at least one heating element of the steam generator can be seen as a correcting variable of the respective regulator.

Generally a change in the heating power induced into the at least one cooking chamber heat radiator brings about a change in the cooking chamber temperature and a change in the heating power induced into the at least one heating element brings about a change in the volume of steam generated (which in turn can indirectly bring about a change in the cooking chamber temperature).

During the regulating phase the cooking chamber temperature is used as the control variable of the at least one first regulator and a first regulator target value is used as its reference variable. The same cooking chamber temperature is used as a control variable of the at least one second regulator and a second regulator target value is used as its reference variable. The regulator target values can be predetermined in particular by a control facility. The target values can be predetermined for example by a control facility. The regulators can be independent components of the steam cooking appliance or can be integrated in the control unit.

That the first regulator target value (for the at least one cooking chamber heat radiator) is greater than or equal to the second regulator target value (for the at least one heating element of the steam cooking appliance) has the advantage that it results in a particularly advantageous ratio between moisture content and water or energy consumption. This recognizes that the difference between these two target values has a major influence on the moisture or degree of humidity in the cooking chamber. The greater the amount of the difference, the less excess humidity there is in the cooking chamber. This typically results in a temperature range for the measured cooking chamber temperature between the second regulator target value and the higher first regulator target value, in which at least one cooking chamber heat radiator is still energized (even if only slightly), while no more steam is generated.

In one embodiment the first regulator target value is up to 5° C. greater than the second regulator target value. This already results in a significant reduction in water or energy consumption and/or the cooking period for the same or an even better cooking result.

In one embodiment the first regulator target value is greater than the second regulator target value, in particular between 1° C. and 4° C. greater. This results in an even more significant increase in the moisture content in the cooking chamber and/or an even more significant in the cooking period for the same or an even better cooking result.

In one embodiment the first regulator target value is 3° C. greater than the second regulator target value. This results in a quite particularly more significant reduction in water or energy consumption and/or the cooking period for the same or an even better cooking result.

In one embodiment the first regulator target value and the second regulator target value are a function of a setpoint value of the cooking chamber temperature. This allows particularly fine and food-based setting of appropriate target values.

If the first regulator target value is designated as Tziel_1, the second regulator target value as Tziel_2 and a setpoint cooking chamber temperature as Tgs, Tziel_1 and Tziel_2 can be calculated for example using Tziel_1=a. Tgs+b or as Tziel_2=c. Tgs+d. The coefficients a to d can in principle be any values, as long as they are fixed. This calculation can be implemented relatively easily and allows for example simple adjustment for the position and type of cooking chamber temperature sensor used. Calculation of the first regulator target value Tziel_1 and the second regulator target value Tziel_2 from the setpoint cooking chamber temperature Tgs has the advantage that cooking chamber temperatures Tg measured thus by the cooking chamber temperature sensor can be adjusted to the fact that the cooking chamber temperature sensor is frequently located in a position in the cooking chamber 2 which does not measure the setpoint cooking chamber temperature Tgs ideally prevailing in the center of the cooking chamber but a different cooking chamber temperature. Thus the measured cooking chamber temperature Tg can be different from the cooking chamber temperature in the center of the cooking chamber when the cooking chamber temperature sensor is located in proximity to the top of the cooking chamber and/or in proximity to a cooking chamber heat radiator. This results in a offset in the value and/or responsiveness, which can be compensated for by the conversion Tziel_1=a. Tgs+b or Tziel_2=c. Tgs+d. If for example the setpoint cooking chamber temperature Tgs is set at 120° C. and the cooking chamber temperature senor is in a position where there is a systematic difference of +5° C. between the cooking chamber temperature Tg and the cooking chamber temperature in the center of the cooking chamber with otherwise identical responsiveness, Tziel_1 could be set for example using a=1 and b=+5° C. at 125° C. If Tziel_2 is then for example only 125° C.−3° C.=122° C., steam generation is already set at Tg=122° C. (corresponding to a cooking chamber temperature of 117° C. in the center of the cooking chamber), while the at least one cooking chamber heat radiator is still energized up to Tg=125° C. corresponding to a cooking chamber temperature of 120° C. in the center of the cooking chamber.

If the cooking chamber temperature sensor were to measure the cooking chamber temperature in the center of the cooking chamber, the settings could be Tziel_1=Tgs and Tziel_2=Tgs−[0° C.; 5° C.], etc.

As set out above, Tziel_2=Tziel_1−[0° C.; 5° C.], in particular Tziel_2=Tziel_1−3° C.

In one embodiment the steam cooking appliance is designed to heat up the cooking chamber at the start of a steam cooking operation or sequence (heat up phase) to then transition to the regulating phase, in which the regulators regulate to the corresponding target or setpoint values Tziel_1 or Tziel_2.

The heat up phases for the first regulator and second regulator can be different. The heat up phase for the first regulator can transition to an associated regulating phase earlier or later than the heat up phase for the second regulator.

In one development the steam cooking appliance is designed, during the heat up phase(s), which can themselves be divided into multiple sub-phases, to operate the at least one cooking chamber heat radiator and/or the at least one heating element of the steam cooking appliance in an unregulated manner, for example with any duty cycle, as long as it is fixed, which can also equal one. This allows a constant, for example constant mean, heating power to be induced into the at least one cooking chamber heat radiator and/or the at least one heating element of the steam cooking appliance in particular during the heat up phase or during the sub-phases.

In one embodiment the heat up phase comprises a number of sub-phases, the heating power induced into the at least one cooking chamber heat radiator and/or the at least one heating element of the steam cooking appliance being reduced successively during the transition to subsequent sub-phases. This advantageously reduces the risk and/or extent of cooking chamber temperature overshooting. It can be brought about for example by reducing the power factors assigned to the sub-phases, which define the heating power induced, from one sub-phase during transition to the following sub-phase. The reduction can be achieved for example by decreasing the respective duty cycle and/or deactivating or not using previously activated cooking chamber heat radiators and/or heating elements or heating circuits. The sub-phases for the first regulator can be longer or shorter than the sub-phases for the second regulator.

In one development the heat up phase for the first regulator transitions or is switched to the regulating phase for the first regulator when the cooking chamber temperature Tg reaches or exceeds a first “heat up” temperature threshold value Tauf_1. The first heat up temperature threshold value Tauf_1 can be a function of the setpoint cooking chamber temperature Tgs and be calculated for example using Tauf_1=e. Tgs+f and be predetermined for example by the control facility.

In one development the heat up phase for the second regulator transitions or is switched to the regulating phase for the second regulator when the cooking chamber temperature Tg reaches or exceeds a second “heat up” temperature threshold value Tauf_2. This second heat up temperature threshold value can be a function of the setpoint cooking chamber temperature Tgs and be calculated for example using Tauf_2=g. Tgs+h and be predetermined for example by the control facility.

In one development the heat up phase for the first regulator is divided into two sub-phases, the initial (heat up) sub-phase transitioning or being switched to the following (heat up) sub-phase for the first regulator when the cooking chamber temperature Tg reaches or exceeds a first “switch” temperature threshold value Tsw_1. This first switch temperature threshold value can be a function of the setpoint cooking chamber temperature Tgs and be calculated for example using Tsw_1=k. Tgs+m and be predetermined for example by the control facility.

In one development the heat up phase for the second regulator is divided into two sub-phases, the initial (heat up) sub-phase transitioning or being switched to the following (heat up) sub-phase for the second regulator when the cooking chamber temperature Tg reaches or exceeds a first “switch” temperature threshold value Tsw_2. This second switch temperature threshold value can be a function of the setpoint cooking chamber temperature Tgs and be calculated for example using Tsw_2=n. Tgs+p and be predetermined for example by the control facility.

The coefficients e to h, k, m, n and p can in principle be any values, as long as they are fixed. These coefficients can be determined for example by experimentation and/or simulation.

Typically Tziel_1>Tauf_1>Tsw_1 and Tziel_2>Tauf_2>Tsw_2.

Generally Tziel_1, Tziel_2, Tauf_1, Tauf_2, Tsw_1 and Tsw_2 can be calculated by formula or be calculated or determined from characteristic curves or tables.

In one embodiment a cooking chamber heat radiator in the form of a bottom heat heating unit is activated at least in phases to carry out the steam cooking operation. This advantageously reduces or even practically completely prevents the collection of condensed water at the bottom of the cooking chamber. This is particularly advantageous in the heat up phase, specifically in the first sub-phase if there is one. Activation of the bottom heat heating unit causes the condensate to evaporate again and be effectively reused for the steam treatment. The quantity of water remaining at the end of cooking is also reduced and less water is used from the reservoir of the steam generator, thereby extending the potential steam cooking period. The heating power of the bottom heat heating unit is advantageously set so that the radiated heat does not adversely affect the food to be cooked. To reach the required cooking chamber temperature, at least one further cooking chamber heat radiator, e.g. the ring heating unit, can advantageously be operated in addition to the bottom heat heating unit.

In one embodiment a setpoint cooking chamber temperature is above a boiling temperature of water. This has the advantage that superheated steam can be generated in the cooking chamber, allowing particularly fast steam cooking. It also keeps condensation in the cooking chamber to a minimum. Specifically it prevents the formation of condensate that drips down from the top of the cooking chamber. It also reduces or even prevents the formation of condensate on the bottom of the oven, inside the door and on the side walls of the cooking chamber. There is therefore no need to dry the oven after a steam cooking operation.

The object is also achieved by a method for operating a steam cooking appliance as described above, wherein the at least one first regulator actuates the at least one cooking chamber heat radiator based on the cooking chamber temperature as a control variable and the first regulator target value as a reference variable and the at least one second regulator actuates the at least one heating element of the steam generator based on the cooking chamber temperature as a control variable and the second regulator target value as a reference variable. The method can be configured in the same way as the steam cooking appliance and has the same advantages.

The characteristics, features and advantages of the present invention described above and the manner in which they are achieved will become clearer and more readily comprehensible in conjunction with the following schematic description of an exemplary embodiment, described in more detail with reference to the drawings.

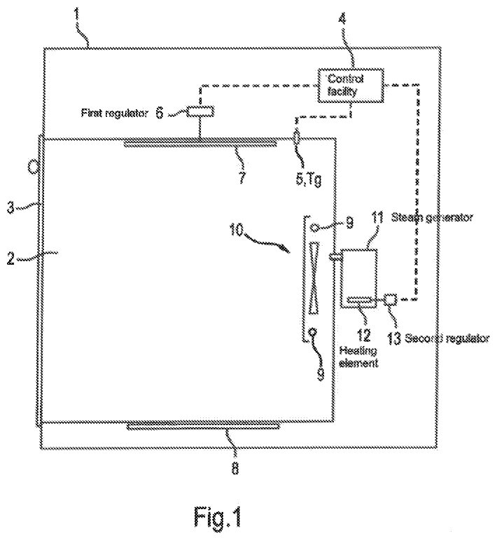

FIG. 1 shows a sectional side view of an outline of a steam cooking appliance;

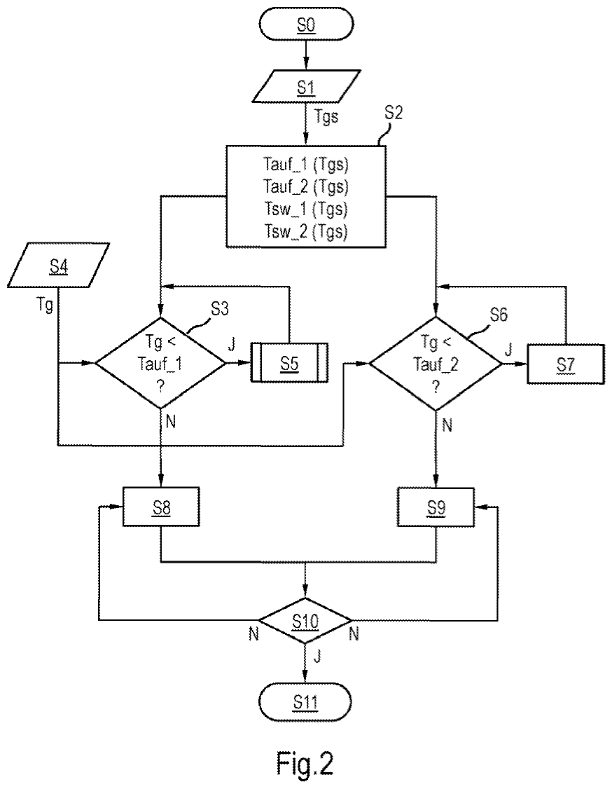

FIG. 2 shows a possible sequence for superheated steam operation of the steam cooking appliance; and

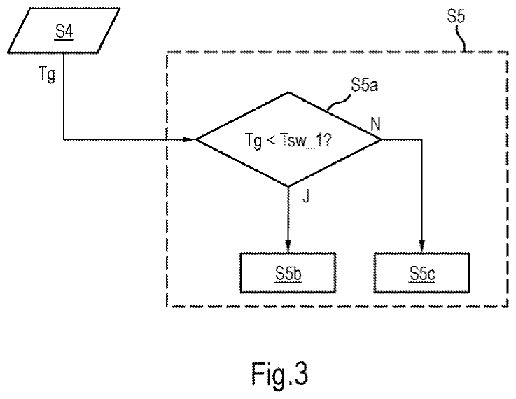

FIG. 3 shows a detailed representation of a sequence step from FIG. 2.

FIG. 1 shows an outline of a steam cooking appliance 1 with a cooking chamber 2, the front loading opening of which can be closed by means of a door 3. When the door 3 is closed, the cooking chamber 2 is pressureless in particular in that no or no significant overpressure builds up therein. The steam cooking appliance 1 can be configured as an oven with additional steam generation function.

The steam cooking appliance 1 has a control facility 4, which is connected to a cooking chamber temperature sensor 5. The cooking chamber temperature sensor 5 measures a cooking chamber temperature Tg in the cooking chamber 2, which can be used by the control facility 4 to control a cooking operation, in particular to regulate the cooking chamber temperature Tg to a threshold value Tgs for cooking chamber temperature predetermined by a user or a cooking program, this being predetermined for example for the center of the cooking chamber 2.

The control facility 4 also sends a first target value Tziel_1 to a first regulator, for example a PID controller, which is designed to actuate or energize at least one cooking chamber heat radiator 7, 8, 9 so that the measured cooking chamber temperature Tg reaches a first target value Tziel_1. To this end the first regulator 6 can actuate one or multiple cooking chamber heat radiators 7, 8, 9 or multiple cooking chamber heat radiators 7, 8, 9 can be actuated by respective first regulators 6. In one development the cooking chamber heat radiators 7, 8, 9 can be activated or deactivated individually. In the present instance the cooking chamber heat radiators 7, 8, 9 comprise by way of example a top heat heating unit or an individually activatable top heat/grill heating unit combination 7, a bottom heat heating unit 8 and a ring heating unit 9, which can be part of a hot air system 10. The cooking chamber heat radiators 7, 8, 9 can be configured as electric resistance heating units, e.g. as tubular heating units.

The steam cooking appliance 1 also has a steam generator 11, which has at least one heating element 12 for evaporating water. The resulting steam is conducted into the cooking chamber 2. The at least one heating element 12 is actuated by a second regulator 13, e.g. a PID controller, which is designed to actuate or energize at least one heating element 12 so that the measured cooking chamber temperature Tg reaches the second target value Tziel_2, which can be transferred from the control facility 4. The greater the control difference Tgs−Tziel_2, the more heating power is introduced into the water to be evaporated and the greater the resulting volume of steam.

Although the regulators 6, 13 are shown as independent components of the steam cooking appliance 1 here, they can also be integrated in the control facility 4.

The steam cooking appliance 1 can be operated in at least one conventional, steam-free heating mode, in which the cooking chamber 2 is heated by at least one of the cooking chamber heat radiators 7, 8, 9 but the steam generator 11 remains deactivated. Alternatively the steam cooking appliance 1 can be operated in a pure steam mode, in which only the steam generator 11 is activated, while the cooking chamber heat radiators 7, 8, 9 remain deactivated. The steam cooking appliance 1 can also be operated in a combined mode, in which the steam generator 11 is activated and at least one of the cooking chamber heat radiators 7, 8, 9 is operated, in particular also at the same time. If the setpoint cooking chamber temperature Tgs is above the boiling temperature of water, the steam in the cooking chamber 2 is heated above its boiling point, which can also be referred to as superheated steam operation.

FIG. 2 shows a possible sequence of a superheated steam cooking operation of the steam cooking appliance 1.

The method starts in a step S0.

In a step S1 a setpoint cooking chamber temperature Tgs of more than 100° C., e.g. from 110° C. to 130° C., provided for the center of the cooking chamber 2, is received for example by means of a user input or from a cooking program. The steps S0 and S1 can also be performed in reverse order or at the same time.

In a step S2 the following further temperature values are calculated from the setpoint cooking chamber temperature Tgs:
a first regulator target value Tziel_1 as a reference value for the regulator 6 of the at least one cooking chamber heat radiator 7 to 9 using Tziel_1=a. Tgs+b;
a second regulator target value Tziel_2 as a reference value for the regulator 13 of the heating element 12 using Tziel_2=c. Tgs+d;
a first “heat up” temperature threshold value Tauf_1=e. Tgs+f;
a second “heat up” temperature threshold value Tauf_2=g. Tgs+h;
a first “switch” temperature threshold value Tsw_1=k. Tgs+m;
a second “switch” temperature threshold value Tsw_2=n. Tgs+p.

The coefficients a to h, k, m, n, and p can in principle be any selected values, as long as they are fixed. These coefficients can be determined for example by experimentation and/or simulation.

Typically Tziel_1>Tauf_1>Tsw_1 and Tziel_2>Tauf_2>Tsw_2.

Also Tziel_2=Tziel_1−[0° C.; 5° C.], in particular Tziel_2=Tziel_1−3° C.

In step S3 it is checked whether or not a current cooking chamber temperature Tg measured (continuously or quasi-continuously) by the cooking chamber temperature sensor 5 in step S4 is below the heat up temperature threshold value Tauf_1.

If so (“Y”), the method branches to step S5. FIG. 3 shows a detailed representation of step S5. In step S5 it is checked in a sub-step S5a whether or not the current cooking chamber temperature Tg is below the switch temperature threshold Tsw_1.

If so (“Y”), the method branches to step S5b. In step S5b first power factors are set or maintained, by means of which the regulator 6 (further) actuates the at least one cooking chamber heat radiator 7 to 9. The power factors A determine the quantity of energy fed into the at least one cooking chamber heat radiator 7 to 9 as a function of a regulator signal of the regulator 6 (e.g. a PWM signal).

If not (“N”), the method branches to step S5c. In step S5c there is a switch to second power factors B, which are smaller than the power factors A. The quantity of energy fed in using the power factors B is then smaller than for the power factors A. The method then branches back to step S3.

At the start of the steam cooking sequence the cooking chamber 2 is first heated up quickly (e.g. with energy up to 1200 W) using the first power factor(s) A as part of a first sub-phase of a heat up phase of the first regulator 6 and then the quantity of energy fed in is reduced before the first regulator target value Tziel_1 is reached (e.g. to 800 W) as part of a second sub-phase of the heat up phase.

In one variant at least the bottom heat heating unit 8 and the ring heating unit 9 are operated until the switch temperature threshold Tauf_1 is reached, then for example only the ring heating unit 9.

In steps S6 and S7 the same procedure is used to heat the steam generator 11 or the at least one heating element 12 as in steps S3 and S5.

In step S6 it is checked whether or not a current cooking chamber temperature Tg measured (continuously or quasi-continuously) by the cooking chamber temperature sensor 5 in step S4 is below a heat up temperature threshold value Tauf_2.

If so (“Y”) in step S7 the method branches to a step S7a (not shown) like step S5a, in which it is checked whether or not the current cooking chamber temperature Tg is below the switch temperature threshold Tsw_2.

If so (“Y”) the method branches to a step S7b (not shown) like step S5b, in which second power factors A* are set or maintained, by means of which the second regulator 13 (further) actuates the at least one heating element 12. The power factors A* determine the quantity of energy fed into the at least one heating element 12 as a function of a regulator signal of the second regulator 13.

If not (“N”), the method branches to a step S7c (not shown) like step S5c. In step S7c there is a switch to second power factors B*, which are smaller than the power factors A*. The quantity of energy fed in using the power factors B* is then smaller than for the power factors A*. The method then branches back to step S3.

At the start of the steam cooking sequence the water in the steam generator 11 is first quickly heated to boiling using the first power factor(s) A*, in other words initially, in particular, as part of a first sub-phase of a heat up phase of the second regulator 13 and then the quantity of energy fed in and therefore the volume of steam generated is reduced even before the second regulator target value Tziel_2 is reached as part of a second sub-phase of a heat up phase of the second regulator 13.

In one variant the steam generator 11 has two heating circuits, both heating circuits being operated until the second switch temperature threshold Tauf_1 is reached, then just one heating circuit. Alternatively or additionally the energy input into at least one of the heating circuits is reduced.

If in step S3 the measured current cooking chamber temperature Tg is no longer below the first heat up temperature threshold value Tauf_1 (“N”), the method branches to step S8. In step S8 the regulator 6 attempts, in a manner known in principle, to set the heating power of the cooking chamber heat radiators using the power factors B so that the cooking chamber temperature Tg is regulated to Tziel_1. The regulator 6 can be configured as a PID controller for this purpose, its regulator signal (which can be a PWM signal for activating and deactivating the cooking chamber heat radiators 7 to 9 still being operated or energized using the power factors B) as a correcting variable being a function of Tg and Tziel_1, in particular the control difference between Tg and Tziel_1. In particular a duty cycle can be smaller, the smaller said difference is.

If, as in step S3, in step S6 the measured current cooking chamber temperature Tg is no longer below the second heat up temperature threshold value Tauf_2 (“N”), the method branches to step S9. In step S9 the second regulator 13 attempts, in a manner known in principle, to set the heating power of the heating circuits using the power factors B* so that the cooking chamber temperature Tg is regulated to Tziel_2. The regulator 13 can also be configured as a PID controller for this purpose, its regulator signal (which can be a PWM signal for example for activating and deactivating the heating elements 12 of the steam generator 11 still being operated or energized using the power factors B*) being a function of Tg and Tziel_2, in particular the control difference between Tg and Tziel_2. In particular a duty cycle can be smaller, the smaller said difference is. The greater the duty cycle, the more steam is generated.

In step S10 it is checked whether one or more termination conditions are met for the steam cooking operation, e.g. whether a predetermined cooking period has been reached and/or a predetermined core temperature of the food being cooked has been reached, etc. If not (“N”), the regulating steps S8 and S9 are continued.

If it is so (“Y”) however, in a step S11 the steam cooking operation is ended, for example by deactivating the steam cooking appliance 1 and there is a transition to an operation without a steam supply, for example keeping warm or a post-cooking operation, etc.

The present invention is of course not limited to the exemplary embodiment shown.

Generally “one”, etc. can refer to a single item or a plurality, in particular in the sense of “at least one” or “one or more”, unless this is specifically excluded, for example by the expression “just one”.

A numerical reference can include the specific number specified as well as a standard tolerance range, unless this is specifically excluded.

### LIST OF REFERENCE CHARACTERS

1 Steam cooking appliance
2 Cooking chamber
3 Door
4 Control facility
5 Cooking chamber temperature sensor
6 First regulator
7 Top heat heating unit
8 Bottom heat heating unit
9 Ring heating unit
10 Hot air system
11 Steam generator
12 Heating element
13 Second regulator
S1-S11 Method steps
Tauf_1 First heat up temperature threshold value
Tauf_1 Second heat up temperature threshold value
Tg Measured cooking chamber temperature
Tgs Setpoint cooking chamber temperature predetermined for the center of the cooking chamber
Tsw_1 First switch temperature threshold value
Tsw_1 Second switch temperature threshold value
Tziel_1 First regulator target value
Tziel_2 Second regulator target value

1-10. (canceled)

11. A steam cooking appliance, comprising:
a pressureless cooking chamber;
a cooking chamber heat radiator designed to heat the cooking chamber;
a cooking chamber temperature sensor designed to detect a cooking chamber temperature;
a steam generator including a heating element designed to heat water to produce steam for supply to the cooking chamber;
a first regulator operably connected to the cooking chamber heat radiator and designed to use during a regulating phase the cooking chamber temperature as a control variable and to use a first regulator target value as a reference variable; and
a second regulator operably connected to the heating element of the steam generator and designed to adopt during the regulating phase the cooking chamber temperature as a control variable and to adopt a second regulator target value as a reference variable,
wherein the first regulator target value is greater than or equal to the second regulator target value.

12. The steam cooking appliance of claim 11, wherein the first regulator target value is up to 5° C. greater than the second regulator target value.

13. The steam cooking appliance of claim 11, wherein the first regulator target value is greater than the second regulator target value by between 1° C. and 4° C.

14. The steam cooking appliance of claim 11, wherein the first regulator target value is greater than the second regulator target value by 3° C.

15. The steam cooking appliance of claim 11, wherein the first regulator target value and the second regulator target value are a function of a setpoint cooking chamber temperature.

16. The steam cooking appliance of claim 15, wherein the setpoint cooking chamber temperature is above a boiling temperature of water.

17. The steam cooking appliance of claim 11, wherein during a heat up phase the steam cooking appliance is designed to heat up the cooking chamber at a start of a steam cooking operation and then to transition to the regulating phase.

18. The steam cooking appliance of claim 17, wherein the heat up phase comprises a number of sub-phases, the steam cooking appliance being designed to reduce a heating power induced into the cooking chamber heat radiator and/or a heating power induced into the heating element of the steam cooking appliance successively during transition to subsequent ones of the sub-phases.

19. The steam cooking appliance of claim 17, wherein the cooking chamber heat radiator is embodied as a bottom heat heating unit and activated at least in one phase to carry out the steam cooking operation.

20. The steam cooking appliance of claim 17, wherein the cooking chamber heat radiator is embodied as a bottom heat heating unit and activated at least in one phase to carry out the heat up phase.

21. A method for operating a steam cooking appliance, the method comprising:
actuating with a first regulator a cooking chamber heat radiator for heating a cooking chamber of the steam cooking appliance based on a cooking chamber temperature as a control variable and a first regulator target value as a reference variable during a regulating phase; and
actuating with a second regulator a heating element of a steam generator for heating water to produce steam for supply to the cooking chamber based on the cooking chamber temperature as a control variable and a second regulator target value as a reference variable during the regulating phase.
wherein the first regulator target value is greater than or equal to the second regulator target value.

22. The method of claim 21, wherein the first regulator target value is up to 5° C. greater than the second regulator target value.

23. The method of claim 21, wherein the first regulator target value is greater than the second regulator target value by between 1° C. and 4° C.

24. The method of claim 21, wherein the first regulator target value is greater than the second regulator target value by 3° C.

25. The method of claim 21, wherein the first regulator target value and the second regulator target value are a function of a setpoint cooking chamber temperature.

26. The method of claim 25, wherein the setpoint cooking chamber temperature is above a boiling temperature of water.

27. The method of claim 21, further comprising heating up during a heat up phase the cooking chamber of the steam cooking appliance at a start of a steam cooking operation and then transitioning to the regulating phase.

28. The method of claim 27, wherein the heat up phase comprises a number of sub-phases, the method further comprising reducing a heating power induced into the cooking chamber heat radiator and/or reducing a heating power induced into the heating element of the steam cooking appliance successively during transition to subsequent ones of the sub-phases.

29. The method of claim 27, further comprising:
embodying the cooking chamber heat radiator as a bottom heat heating unit; and
activating the bottom heat heating unit at least in one phase to carry out the steam cooking operation.

30. The method of claim 27, further comprising:
embodying the cooking chamber heat radiator as a bottom heat heating unit; and
activating the bottom heat heating unit at least in one phase to carry out the heat up phase.
